(19) United States
(12) Patent Application Publication
(10) Pub. No.: US 2025/0049019 A1
(43) Pub. Date: Feb. 13, 2025

(54) SOLAR MOSQUITO KILLER LAMP

(71) Applicant: Meizhen LI, Shenzhen (CN)

(72) Inventor: Meizhen LI, Shenzhen (CN)

(21) Appl. No.: 18/483,299

(22) Filed: Oct. 9, 2023

Related U.S. Application Data
(63) Continuation of application No. 18/451,707, filed on Aug. 17, 2023.

(30) Foreign Application Priority Data
Aug. 7, 2023 (CN) 202322118211.2

(51) Int. Cl. A01M 1/22; A01M 1/04; F21S 9/03

(52) U.S. Cl. CPC A01M 1/223; A01M 1/04; F21S 9/03; F21Y 2115/10

(57) ABSTRACT

A solar mosquito killer lamp includes a light emitted by the LED tube in the first light-emitting unit lures mosquitoes. The lured mosquitoes are killed through a high-voltage power grid. A battery and a circuit board arranged in a mounting shell supply power to the LED tube and the high-voltage power grid. Furthermore, a solar panel module electrically connected to the battery and the circuit board is provided, and can convert sunlight into electric energy and store the electric energy into the battery. Due to the solar panel module, compared with a mosquito killer lamp that only includes a single-layer solar panel, the mosquito killer lamp with the solar panel module enlarges an area of the solar panel, thereby improving the solar energy conversion efficiency. Therefore, the mosquito killer lamp can fully use the sunlight to achieve charging during outdoor use and is conductive to reducing the energy consumption.

### CROSS-REFERENCE TO RELATED APPLICATIONS

This application is a continuation of the U.S. application Ser. No. 18/451,707 filed on Aug. 17, 2023, and entitled “SOLAR MOSQUITO KILLER LAMP,” now pending, and also claims priority of Chinese patent application CN2023221182112, filed on Aug. 7, 2023, the entire disclosures of which are incorporated herein by reference.

### TECHNICAL FIELD

The present disclosure relates to the field of mosquito killer lamps, and particularly to a solar mosquito killer lamp.

### BACKGROUND

In our daily lives, mosquito killer lamps are widely used electronic products, which has many advantages compared to other mosquito products. A mosquito killer lamp neither has a pungent smell like mosquito-repellent incense and insecticides, nor causes chemical pollution, so the mosquito killer lamp is completely harmless to health. A working principle of the mosquito killer lamp is as follows: The mosquito killer lamp lures mosquitoes to get close to a light source using mosquito's tendency toward light and then kills the mosquitoes through an electric mesh around the light source. The mosquito killer lamp has unique features of silence and odorlessness, and would not cause any harm to human. At present, according to the common traditional mosquito killer lamps on the market, an energy storage battery of the mosquito killer lamp is charged by electrical plugging. However, when the mosquito killer lamp is used outdoor, there is often no charging power supply and a low battery. Therefore, there is an urgent need for a mosquito killer lamp on the market that can ensure normal operations under an outdoor condition.

### SUMMARY

In view of this, the present disclosure provides a solar mosquito killer lamp, which can charge a battery using solar energy to achieve normal outdoor operations.

The present disclosure discloses a solar mosquito killer lamp includes a first light-emitting unit. The first light-emitting unit includes a light-emitting diode (LED) tube, wherein the LED tube is configured to emit light luring mosquitoes; a mosquito killer unit includes a high-voltage power grid, wherein the high-voltage power grid is configured to kill, under a high voltage, mosquitoes lured by the LED tube; a circuit board, electrically connected to the first light-emitting unit and the mosquito killer unit and configured to supply power to the first light-emitting unit and the mosquito killer unit; a mounting shell, wherein the mounting shell is provided with a battery; the battery is electrically connected to the circuit board; the circuit board is arranged to the mounting shell; the first light-emitting unit and the mosquito killer unit are connected to the mounting shell; and a solar panel, wherein the solar panel is a two-layer solar panel; the solar panel is connected to the mounting shell; and the solar panel is electrically connected to the circuit board and the battery.

As the improvement of the present disclosure, the solar panel includes a first layer of solar panel; and the first layer of solar panel is arranged on an upper end surface of the mounting shell.

As the improvement of the present disclosure, a first accommodating slot is formed in the upper end surface of the mounting shell; an upwards protruding contact is arranged on a bottom of the first accommodating slot; the first layer of solar panel is arranged in the first accommodating slot; and the first layer of solar panel is electrically connected to the battery and the circuit board through the contact.

As the improvement of the present disclosure, the mounting shell is rotatably connected with a cover body; the cover body is provided with a second accommodating slot; the solar panel includes a second layer of solar panel; the second layer of solar panel is arranged in the second accommodating slot; and the second layer of solar panel is electrically connected to the circuit board and the battery.

As the improvement of the present disclosure, the cover body includes a first cover body; the first cover body is flipped and rotated with the mounting shell through a first rotating shaft mechanism; the first rotating shaft mechanism is horizontally arranged between the first cover body and the mounting shell, and the first cover body is flipped up and down to cover the upper end face of the mounting shell through the first rotating shaft mechanism; the first cover body is provided with a third accommodating slot; the second layer of solar panel includes a first solar panel; the first solar panel is arranged in the third accommodating slot; and when the first cover body is flipped to open, the first layer of solar panel and the second layer of solar panel work simultaneously.

As the improvement of the present disclosure, the cover body includes a second cover body; the second cover body is rotatably connected to the mounting shell through a second rotating shaft mechanism; the second rotating shaft mechanism is vertically arranged between the second cover body and the mounting shell, and the second cover body slides left and right to cover the upper end face of the mounting shell through the second rotating shaft mechanism; the second cover body is provided with a fourth accommodating slot; the second layer of solar panel includes a second solar panel; the second solar panel is arranged in the fourth accommodating slot; and when the second cover body slides to rotatably open, the first layer of solar panel and the second layer of solar panel work simultaneously.

As the improvement of the present disclosure, the cover body includes a third cover body and a fourth cover body; the third cover body and the fourth cover body are respectively rotatably connected to the mounting shell through a third rotating shaft mechanism and a fourth rotating shaft mechanism; the third rotating shaft mechanism is horizontally arranged between the third cover body and the mounting shell, and the fourth rotating shaft mechanism is horizontally arranged between the fourth cover body and the mounting shell; the third cover body and the fourth cover body are respectively flipped and rotated up and down through the third rotating shaft mechanism and the fourth rotating shaft mechanism, and jointly cover the upper end face of the mounting shell; the third cover body is provided with a fifth accommodating slot; the second layer of solar panel includes a third solar panel; the third solar panel is arranged in the fifth accommodating slot; the fourth cover body is provided with a sixth accommodating slot, and the second layer of solar panel includes a fourth solar panel; the fourth solar panel is arranged in the sixth accommodating slot; and when the third cover body and the fourth cover body are flipped to open, the first layer of solar panel and the second layer of solar panel work simultaneously.

As the improvement of the present disclosure, the cover body includes a fifth cover body and a sixth cover body; the fifth cover body and the sixth cover body are rotatably connected to the mounting shell through a fifth rotating shaft mechanism; the fifth rotating shaft mechanism is vertically arranged among the fifth cover body, the sixth cover body, and the mounting shell; the fifth cover body and the sixth cover body slide left and right through the fifth rotating shaft mechanism and jointly cover the upper end face of the mounting shell; the fifth cover body is provided with a seventh accommodating slot; the second layer of solar panel includes a fifth solar panel; the fifth solar panel is arranged in the seventh accommodating slot; the sixth cover body is provided with an eighth accommodating slot, and the second layer of solar panel includes a sixth solar panel; the sixth solar panel is arranged in the eighth accommodating slot; and when the fifth cover body and the sixth cover body slide relatively to rotatably open, the first layer of solar panel and the second layer of solar panel work simultaneously.

As the improvement of the present disclosure, the LED tube includes a circuit board; the circuit board is provided with several LEDs; one end of the circuit board is connected with an electrifying device; the electrifying device is connected with a first end cover; a pin is mounted on the first end cover; the pin is electrically connected to the electrifying device; and the other end of the circuit board is connected with a second end cover.

As the improvement of the present disclosure, the LED tube further includes a scattering structure and a transparent tube body; the scattering structure and the transparent tube body enclose the circuit board; one end of the scattering structure is connected to the first end cover; the other end of the scattering structure is connected to the second end cover; one end of the transparent tube body is connected to the first end cover; and the other end of the transparent tube body is connected to the second end cover.

As the improvement of the present disclosure, the several LEDs are irregularly arranged on the circuit board; and the LEDs adopt LEDs with a wavelength of 365 to 380 nm and LEDs with a wavelength of 380 to 400 nm.

As the improvement of the present disclosure, the LED tube is detachably connected to the mounting shell; the mounting shell includes an upper shell and a base; the upper shell is provided with a first clamping slot and a first fixing member; the first fixing member is provided with a mounting hole; the pin is detachably plugged into the mounting hole; the first end cover is detachably plugged into the first clamping slot; the base is provided with a second clamping slot and a second fixing member; and the second end cover is detachably plugged into the second clamping slot through the second fixing member.

As the improvement of the present disclosure, the high-voltage power grid is arranged around the LED tube; one end of the high-voltage power grid is connected to the upper shell, and the other end of the high-voltage power grid is connected to the base; the base is provided with a killed mosquito opening and a bottom cover; the bottom cover is detachably connected to the base; when the high-voltage power grid kills mosquitoes, the mosquitoes killed by the high-voltage power grid enter and fall onto the bottom cover through the killed mosquito opening.

As the improvement of the present disclosure, the high-voltage power grid includes an inner grid and an outer grid; the inner grid and the outer grid each include a plurality of gratings; and the gratings of the inner grid and the gratings of the outer grid are staggered.

As the improvement of the present disclosure, the solar mosquito killer lamp further includes a lampshade, wherein the lampshade is a grid hollow lampshade; an upper end of the lampshade is connected to a bottom of the upper shell, and a lower end is connected to a top of the base; and the LED tube and the high-voltage power grid are both arranged in the lampshade.

As the improvement of the present disclosure, the upper shell is provided with an accommodating cavity; and the circuit board and the battery are both arranged in the accommodating cavity.

As the improvement of the present disclosure, the solar mosquito killer lamp further includes a second light-emitting unit, wherein the second light-emitting unit includes several LEDs; the LEDs are uniformly arranged around a periphery of the upper shell; the upper shell is further provided with a transparent cover body; and the transparent cover body covers the LEDs.

As the improvement of the present disclosure, a first stepless adjustment knob, a second stepless adjustment knob, and a switch are arranged on an outer surface of the upper shell; the first stepless adjustment knob is configured to adjust brightness of the LEDs; the second stepless adjustment knob is configured to adjust a wavelength of the LED tube; and the switch is configured to control the mosquito killer lamp to be turned on or turned off.

As the improvement of the present disclosure, the upper shell is further provided with a charging port; and the charging port is electrically connected to the circuit board and is configured to connect an external power supply.

As the improvement of the present disclosure, the mosquito killer lamp further includes a handle portion; the handle portion is rotatably connected to the mounting shell; and the handle portion is configured to carry the mosquito killer lamp.

Beneficial effects: the present disclosure discloses a light emitted by the LED tube in the first light-emitting unit lures mosquitoes, and the lured mosquitoes are killed through the high-voltage power grid. The battery and the circuit board which are arranged in the mounting shell supply power to the LED tube and the high-voltage power grid. Furthermore, the two-layer solar panel electrically connected to the battery and the circuit board is provided, and can convert the sunlight into electric energy and store the electric energy into the battery. Due to the two-layer solar panel, compared with a mosquito killer lamp that only includes a single-layer solar panel, the mosquito killer lamp with the two-layer design enlarges an area of the solar panel, thereby improving the solar energy conversion efficiency. Therefore, the mosquito killer lamp can fully use the sunlight to achieve charging during outdoor use, and is conductive to reducing the energy consumption and the environmental pollution.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is an overall structural diagram of a mosquito killer lamp of the present disclosure;

FIG. 2 is an exploded diagram of a mosquito killer lamp of the present disclosure;

FIG. 3 is a sectional diagram of a mosquito killer lamp of the present disclosure;

FIG. 4 is an exploded diagram of an LED tube of a mosquito killer lamp of the present disclosure;

FIG. 5 is an exploded diagram of an upper shell and a base of a mosquito killer lamp of the present disclosure;

FIG. 6 is another exploded diagram of a mosquito killer lamp of the present disclosure;

FIG. 7 is an exploded diagram of a solar panel according to one embodiment of a mosquito killer lamp of the present disclosure;

FIG. 8 is an exploded diagram of a solar panel according to another embodiment of a mosquito killer lamp of the present disclosure;

FIG. 9 is an exploded diagram of a solar panel according to another embodiment of a mosquito killer lamp of the present disclosure; and

FIG. 10 is an exploded diagram of a solar panel according to another embodiment of a mosquito killer lamp of the present disclosure.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the utility model, but not all embodiments are based on the embodiment of the utility model, and all other embodiments obtained by ordinary technicians in the field on the premise of not doing creative work belong to the protection range of the utility model.

In order to make the aims, technical solution and advantages of the present disclosure will be clearly, the present disclosure is further described below in combination with accompanying drawings and implementations.

The terms “first”, “second”, “first”, and the like in the specification and claims of the present disclosure and the above drawings are used to distinguish similar objects, and are not intended to describe a specific sequence. In addition, the terms “include” and any variations thereof mean covering and non-exclusive inclusion. For example, processes, methods, systems, products, or devices which include a series of steps or units are not limited to listed steps or units, but selectively further include steps or units which are not listed, or selectively further include other steps or units which are inherent to these processes, methods, products, or devices.

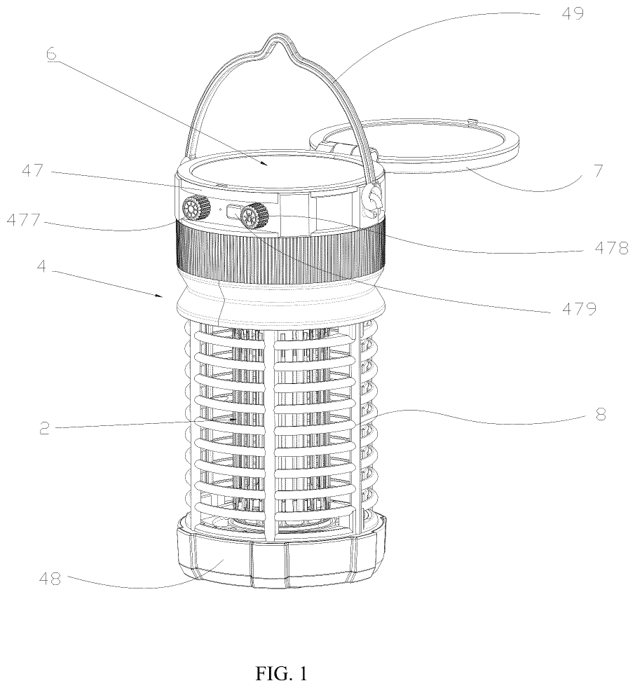

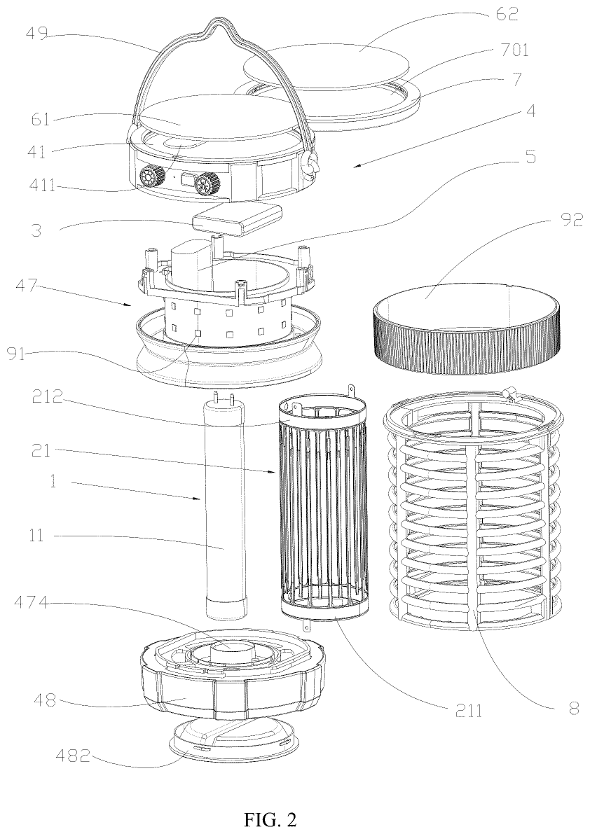

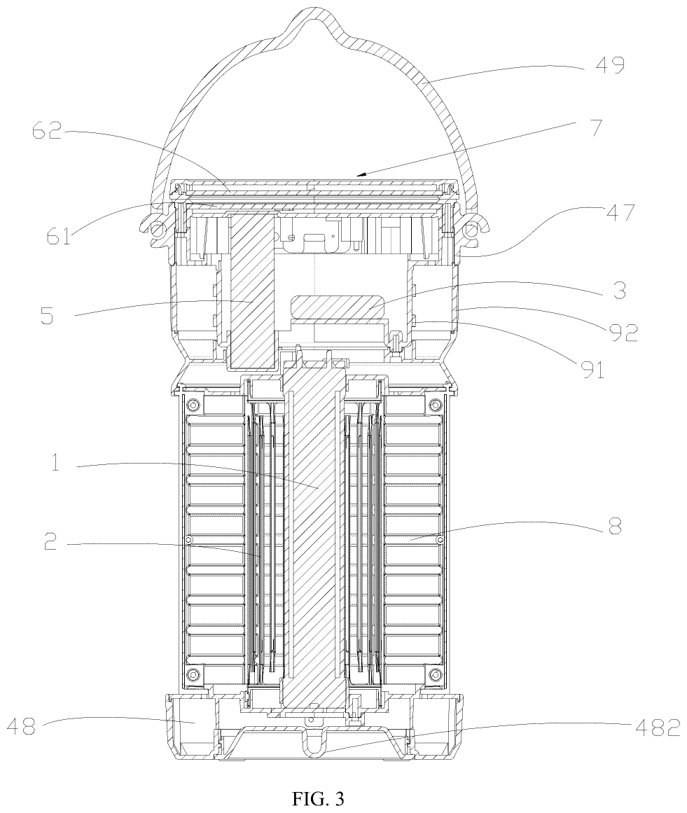

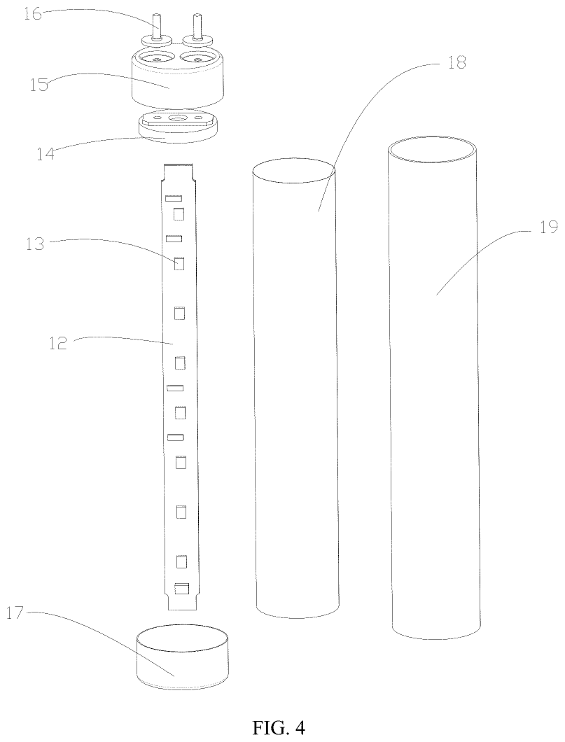

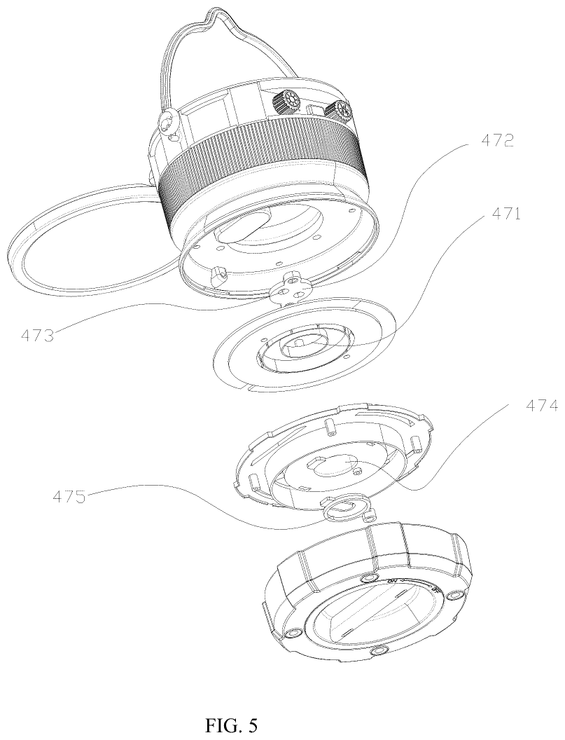

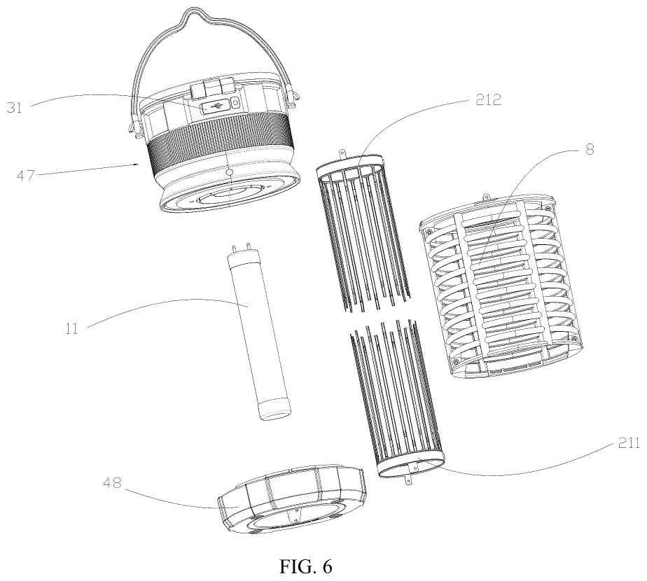

Referring to FIG. 1 to FIG. 6, a solar mosquito killer lamp includes a first light-emitting unit 1, wherein the first light-emitting unit 1 includes an LED tube 11, and the LED tube 11 is configured to emit light luring mosquitoes; a mosquito killer unit 2, including a high-voltage power grid 21, wherein the high-voltage power grid 21 is configured to kill, under a high voltage, mosquitoes lured by the LED tube 11; a circuit board 3, electrically connected to the first light-emitting unit 1 and the mosquito killer unit 2 and configured to supply power to the first light-emitting unit 1 and the mosquito killer unit 2; a mounting shell 4, wherein the mounting shell 4 is provided with a battery 5; the battery 5 is electrically connected to the circuit board 3; the circuit board 3 is arranged to the mounting shell 4; the first light-emitting unit 1 and the mosquito killer unit 2 are connected to the mounting shell 4; and a solar panel 6, wherein the solar panel 6 is a two-layer solar panel 6; the solar panel 6 is connected to the mounting shell 4; and the solar panel 6 is electrically connected to the circuit board 3 and the battery 5. By means of the above structure, the light emitted by the LED tube 11 in the first light-emitting unit 1 lures mosquitoes, and the lured mosquitoes are killed through the high-voltage power grid 21. The battery 5 and the circuit board 3 which are arranged in the mounting shell 4 supply power to the LED tube 11 and the high-voltage power grid 21. Furthermore, the two-layer solar panel 6 electrically connected to the battery 5 and the circuit board 3 is provided, and can convert the sunlight into electric energy and store the electric energy into the battery 5. Due to the two-layer solar panel 6, compared with a mosquito killer lamp that only includes a single-layer solar panel, the mosquito killer lamp with the two-layer design enlarges an area of the solar panel 6, thereby improving the solar energy conversion efficiency. Therefore, the mosquito killer lamp can fully use the sunlight to achieve charging during outdoor use, and is conductive to reducing the energy consumption and the environmental pollution.

In this embodiment, the solar panel 6 includes a first layer of solar panel 61; and the first layer of solar panel 61 is arranged on an upper end surface of the mounting shell 4. A first accommodating slot 41 is formed in the upper end surface of the mounting shell 4; an upwards protruding contact 411 is arranged on a bottom of the first accommodating slot 41; the first layer of solar panel 61 is arranged in the first accommodating slot 41; and the first layer of solar panel 61 is electrically connected to the battery 5 and the circuit board 3 through the contact 411. By means of the above structure, the first layer of solar panel 61 is ingeniously mounted on the upper end surface of the mounting shell 4, so that the solar panel 61 can be exposed to the sunlight to the largest extent, thereby collecting solar energy to the largest extent. Collection of sufficient solar energy means higher electric energy storage. At night or in a case of inadequate light, the solar mosquito killer lamp can still work normally.

In this embodiment, the mounting shell 4 is rotatably connected with a cover body 7; the cover body 7 is provided with a second accommodating slot 701; the solar panel 6 includes a second layer of solar panel 62; the second layer of solar panel 62 is arranged in the second accommodating slot 701; and the second layer of solar panel 62 is electrically connected to the circuit board 3 and the battery 5. By means of the above structure, the cover body is additionally provided with the second layer of solar panel 62, the solar energy absorption area is enlarged, and the efficiency of energy storage of the battery 5 is improved.

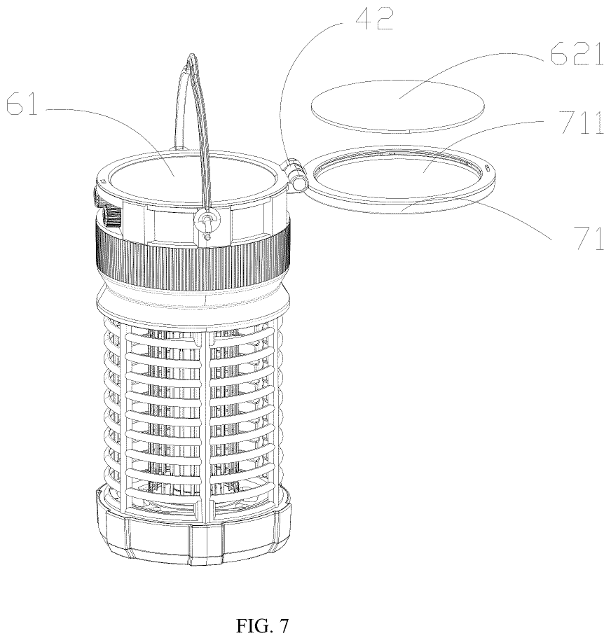

Referring to FIG. 7, the cover body 7 includes a first cover body 71; the first cover body 71 is flipped and rotated with the mounting shell 4 through a first rotating shaft mechanism 42; the first rotating shaft mechanism 42 is horizontally arranged between the first cover body 71 and the mounting shell 4, and the first cover body 71 is flipped up and down to cover the upper end face of the mounting shell 4 through the first rotating shaft mechanism 42; the first cover body 71 is provided with a third accommodating slot 711; the second layer of solar panel 62 includes a first solar panel 621; the first solar panel 621 is arranged in the third accommodating slot 711; and when the first cover body 71 is flipped to open, the first layer of solar panel 61 and the second layer of solar panel 62 can work simultaneously.

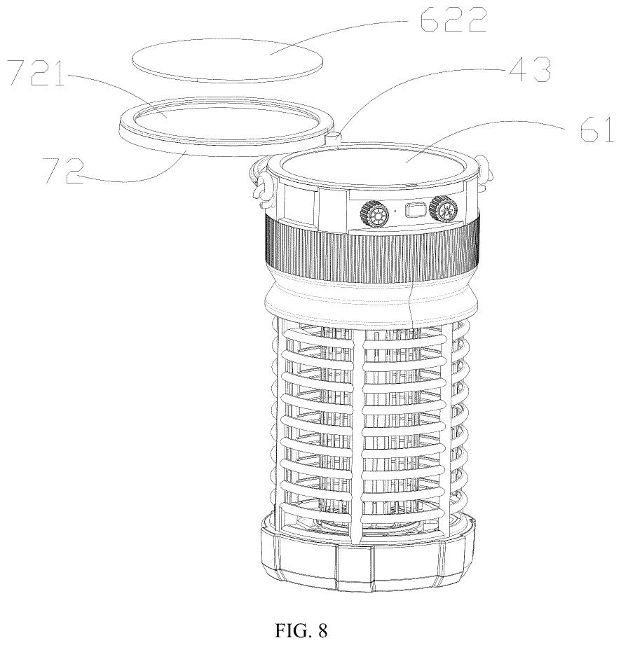

Referring to FIG. 8, the cover body 7 includes a second cover body 72; the second cover body 72 is rotatably connected to the mounting shell 4 through a second rotating shaft mechanism 43; the second rotating shaft mechanism 43 is vertically arranged between the second cover body 72 and the mounting shell 4, and the second cover body 72 slides left and right to cover the upper end face of the mounting shell 4 through the second rotating shaft mechanism 43; the second cover body 72 is provided with a fourth accommodating slot 721; the second layer of solar panel 62 includes a second solar panel 622; the second solar panel 622 is arranged in the fourth accommodating slot 721; and when the second cover body 72 slides to rotatably open, the first layer of solar panel 61 and the second layer of solar panel 62 can work simultaneously.

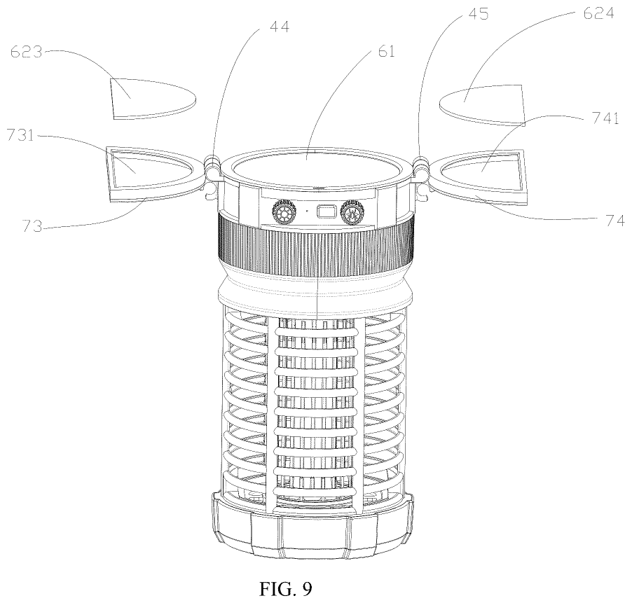

Referring to FIG. 9, the cover body 7 includes a third cover body 73 and a fourth cover body 74; the third cover body 73 and the fourth cover body 74 are respectively rotatably connected to the mounting shell 4 through a third rotating shaft mechanism 44 and a fourth rotating shaft mechanism 45; the third rotating shaft mechanism 44 is horizontally arranged between the third cover body 73 and the mounting shell 4, and the fourth rotating shaft mechanism 45 is horizontally arranged between the fourth cover body 74 and the mounting shell 4; the third cover body 73 and the fourth cover body 74 are respectively flipped and rotated up and down through the third rotating shaft mechanism 44 and the fourth rotating shaft mechanism 45, and jointly cover the upper end face of the mounting shell 4; the third cover body 73 is provided with a fifth accommodating slot 731; the second layer of solar panel 62 includes a third solar panel 623; the third solar panel 623 is arranged in the fifth accommodating slot 731; the fourth cover body 74 is provided with a sixth accommodating slot 741, and the second layer of solar panel 62 includes a fourth solar panel 624; the fourth solar panel 624 is arranged in the sixth accommodating slot 741; and when the third cover body 73 and the fourth cover body 74 are flipped to open, the first layer of solar panel 61 and the second layer of solar panel 62 can work simultaneously.

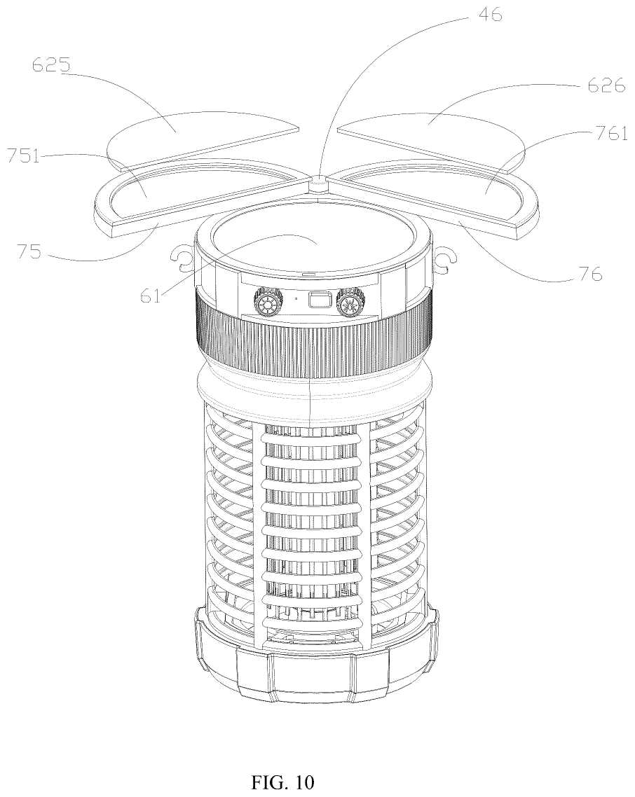

Referring to FIG. 10, the cover body includes a fifth cover body 75 and a sixth cover body 76; the fifth cover body 75 and the sixth cover body 76 are rotatably connected to the mounting shell 4 through a fifth rotating shaft mechanism 46; the fifth rotating shaft mechanism 46 is vertically arranged among the fifth cover body 75, the sixth cover body 76, and the mounting shell 4; the fifth cover body 75 and the sixth cover body 76 slide left and right through the fifth rotating shaft mechanism 46 and jointly cover the upper end face of the mounting shell 4; the fifth cover body 75 is provided with a seventh accommodating slot 751; the second layer of solar panel 62 includes a fifth solar panel 625; the fifth solar panel 625 is arranged in the seventh accommodating slot 751; the sixth cover body 76 is provided with an eighth accommodating slot 761, and the second layer of solar panel 62 includes a sixth solar panel 626; the sixth solar panel 626 is arranged in the eighth accommodating slot 761; and when the fifth cover body 75 and the sixth cover body 76 slide relatively to rotatably open, the first layer of solar panel 61 and the second layer of solar panel 62 can work simultaneously.

In this embodiment, the LED tube 11 includes a circuit board 12; the circuit board is provided with several LEDs 13; one end of the circuit board 12 is connected with an electrifying device 14; the electrifying device 14 is connected with a first end cover 15; a pin 16 is mounted on the first end cover 15; the pin 16 is electrically connected to the electrifying device 14; and the other end of the circuit board 12 is connected with a second end cover 17.

In this embodiment, the LED tube 11 further includes a scattering structure 18 and a transparent tube body 19; the scattering structure 18 and the transparent tube body 19 enclose the circuit board 12; one end of the scattering structure 18 is connected to the first end cover 15; the other end of the scattering structure 18 is connected to the second end cover 17; one end of the transparent tube body 19 is connected to the first end cover 15; and the other end of the transparent tube body 19 is connected to the second end cover 17. Further, the scattering structure 18 is a frosted material structure or a frosted glass material structure. By means of the above structure, the lighting effect of the LED tube can be improved, and the dazzling sensation is relieved, so that light for illumination is more comfortable and warmer.

In this embodiment, the several LEDs 13 are irregularly arranged on the circuit board 12; and the LEDs 13 adopt LEDs 13 with a wavelength of 365 to 380 nm and LEDs 13 with a wavelength of 380 to 400 nm. Preferably, the wavelength can be adjusted to 369 mm to kill mosquitoes and 395 mm to kill insects such as moths. By means of the above structure, light with different wavelengths can attract different insects and kill mosquitoes or moths separately. By combining light sources with different wavelengths, the attraction and insecticidal effect of the mosquito killer lamp can be increased, while unnecessary harm to beneficial insects can be avoided.

In this embodiment, the LED tube 11 is detachably connected to the mounting shell 4; the mounting shell 4 includes an upper shell 47 and a base 48; the upper shell 47 is provided with a first clamping slot 471 and a first fixing member 472; the first fixing member 472 is provided with a mounting hole 473; the pin 16 is detachably plugged into the mounting hole 473; the first end cover 15 is detachably plugged into the first clamping slot 471; the base is provided with a second clamping slot 474 and a second fixing member 475; and the second end cover 17 is detachably plugged into the second clamping slot 474 through the second fixing member 475.

In this embodiment, the high-voltage power grid 21 is arranged around the LED tube 11; one end of the high-voltage power grid 21 is connected to the upper shell 47, and the other end of the high-voltage power grid 21 is connected to the base 48; the base 48 is provided with a killed mosquito opening 481 and a bottom cover 482; the bottom cover 482 is detachably connected to the base 48; when the high-voltage power grid 21 kills mosquitoes, the mosquitoes killed by the high-voltage power grid 21 can enter and fall onto the bottom cover 482 through the killed mosquito opening 481. The high-voltage power grid 21 includes an inner grid 211 and an outer grid 212; the inner grid 211 and the outer grid 212 each include a plurality of gratings; and the gratings of the inner grid and the gratings of the outer grid are staggered. By means of the above structure, when in use, the mosquitoes that have been killed by the high-voltage power grid 21 will fall into the bottom cover 482 from the high-voltage power grid 21, so as to prevent the mosquitoes from directly falling onto the ground. To clean mosquitoes, the bottom cover 482 can be removed from the base 48 to clean the mosquitoes in the bottom cover 482, which is easy to clean and convenient to use. This solves the technical problem that when the traditional mosquito killer lamp is used, mosquito bodies fall onto the ground and are difficult to intensively clean.

In this embodiment, the solar mosquito killer lamp further includes a lampshade 8. The lampshade 8 is a grid hollow lampshade 8; an upper end of the lampshade 8 is connected to a bottom of the upper shell 47, and a lower end is connected to a top of the base 48; and the LED tube 11 and the high-voltage power grid 21 are both arranged in the lampshade 8. By means of the above structure, during use by a user, the grid hollow lampshade 8 can cause mosquitoes to enter the high-voltage power grid 21 and be killed and can also prevent mistouch of the high-voltage power grid 21 caused by the fact that the user accidentally sticks a finger into the lampshade 8, which ensures the practicability and safety of the solar mosquito killer lamp.

In this embodiment, the upper shell 47 is provided with an accommodating cavity 475; and the circuit board 3 and the battery 5 are both arranged in the accommodating cavity 476.

In this embodiment, the solar mosquito killer lamp further includes a second light-emitting unit 9; the second light-emitting unit 9 includes several LEDs 91; the LEDs 91 are uniformly arranged around a periphery of the upper shell 47; the upper shell 47 is further provided with a transparent cover body 92; and the transparent cover body 92 covers the LEDs. By means of the above structure, the LEDs can emit light of illumination through the transparent cover body, which can be used for night lighting.

In this embodiment, a first stepless adjustment knob 477, a second stepless adjustment knob 478, and a switch 479 are arranged on an outer surface of the upper shell 47; the first stepless adjustment knob 477 is configured to adjust brightness of the LEDs; the second stepless adjustment knob 478 is configured to adjust a wavelength of the LED tube 11; and the switch 479 is configured to control the mosquito killer lamp to be turned on or turned off. By means of the above structure, a user can perform stepless adjustment on the brightness according to a corresponding environment. In a dark environment, the user can turn on the LEDs 91 to provide ambient lighting. Since users have different needs for killing mosquitoes, the second stepless adjustment knob can adjust the wavelength to achieve precise killing of different kinds of mosquitoes.

In this embodiment, the upper shell 47 is further provided with a charging port 31; and the charging port 31 is electrically connected to the circuit board 3 and is configured to connect an external power supply. The charging port may adopt a USB interface or a Type-C interface. By means of the above structure, the mosquito killer lamp can be plugged to an external power supply for charging while it is charged using the solar energy.

In this embodiment, the mosquito killer lamp further includes a handle portion 49. The handle portion 49 is rotatably connected to the mounting shell 4, and the handle portion is configured to carry the mosquito killer lamp. By means of the above structure, it is convenient for a user to carry the mosquito killer lamp due to the handle portion, which improves the user experience.

It should be finally noted that the above various embodiments are only used to describe the technical solutions of the present disclosure, and not intended to limit the present disclosure. Although the present disclosure has been described in detail with reference to the foregoing embodiments, those ordinarily skilled in the art should understand that they can still modify the technical solutions described in all the foregoing embodiments, or equivalently replace some or all of the technical features, and these modifications or replacements do not depart the essences of the corresponding technical solutions from the spirit and scope of the technical solutions of all the embodiments of the present disclosure.

1. (canceled)

2. (canceled)

3. (canceled)

4. (canceled)

5. (canceled)

6. (canceled)

7. (canceled)

8. (canceled)

9. (canceled)

10. (canceled)

11. A mosquito killer lamp, comprising:
a first light emitting unit configured to emit light luring mosquitoes;
a mosquito killer unit comprising a high-voltage power grid, wherein the high-voltage power grid is configured to kill, under a high voltage, mosquitoes lured by the first light emitting unit;
a circuit board electrically connected to the first light emitting unit and the mosquito killer unit and configured to supply power to the first light emitting unit and the mosquito killer unit; and
a mounting shell provided with a battery; wherein the battery is electrically connected to the circuit board; the first light emitting unit and the mosquito killer unit are connected to the mounting shell;
wherein the first light emitting unit comprises a light circuit board, a plurality of LEDs disposed on the light circuit board, and a tube body, and the light circuit board is located in the tube body, and
wherein the LEDs comprises a plurality of first LEDs emitting light with a central wavelength ranging from 365 to 380 nm and a plurality of second LEDs emitting light with a central wavelength ranging from 380 to 400 nm.

12. (canceled)

13. (canceled)

14. (canceled)

15. (canceled)

16. (canceled)

17. A mosquito killer lamp, comprising:
a first light emitting unit configured to emit light luring mosquitoes;
a mosquito killer unit comprising a high-voltage power grid, wherein the high-voltage power grid is configured to kill, under a high voltage, mosquitoes lured by the first light emitting unit;
a circuit board electrically connected to the first light emitting unit and the mosquito killer unit and configured to supply power to the first light emitting unit and the mosquito killer unit;
a mounting shell provided with a battery; wherein the battery is electrically connected to the circuit board; the first light emitting unit and the mosquito killer unit are connected to the mounting shell, the mounting shell comprises an upper shell and a base; and
a second light emitting unit,
wherein the second light emitting unit comprises a plurality of LEDs disposed around an outside of the upper shell; the plurality of LEDs of the second light emitting unit are also arranged around the upper shell; the upper shell is further provided with a transparent cover body; the transparent cover body is arranged around an outside of the plurality of LEDs of the second light emitting unit, the transparent cover body connects the upper shell and covers the plurality of LEDs of the second light emitting unit, and the plurality of LEDs of the second light emitting unit are configured to emit light passing through the transparent cover body.

18. The mosquito killer lamp according to claim 17, wherein a first stepless adjustment knob, a second stepless adjustment knob, and a switch are arranged on an outer surface of the upper shell; the first stepless adjustment knob is configured to adjust brightness of the plurality of LEDs of the second light emitting unit; the second stepless adjustment knob is configured to adjust a wavelength of the first light emitting unit; the switch is configured to control the mosquito killer lamp to be turned on or turned off; the first stepless adjustment knob is a rotary knob installed on the mounting shell; and the second stepless adjustment knob is a rotary knob installed on the mounting shell.

19. The mosquito killer lamp according to claim 18, wherein the upper shell is further provided with a charging port; the charging port is electrically connected to the circuit board and is configured to connect an external power supply, and the charging port is a Type-C interface.

20. The mosquito killer lamp according to claim 19,
wherein the mosquito killer lamp further comprises a handle portion; the handle portion is rotatably connected to the mounting shell; and the handle portion is configured to carry the mosquito killer lamp.

21. The mosquito killer lamp according to claim 11, further comprising a second light emitting unit, wherein the second light-emitting unit comprises a plurality of LEDs,
wherein a stepless adjustment rotary knob is arranged on an outer surface of the mounting shell, the stepless adjustment rotary knob is configured to adjust brightness of the LEDs of the second light emitting unit.

22. The mosquito killer lamp according to claim 11,
wherein a second stepless adjustment rotary knob is arranged on an outer surface of the mounting shell; and the second stepless adjustment rotary knob is configured to adjust a wavelength of the LEDs of the first light emitting unit.

23. The mosquito killer lamp according to claim 11, further comprising a solar panel module connected to the mounting shell and electrically connected to the circuit board and the battery,
wherein the solar panel module comprises a first solar panel; and the first solar panel is arranged on the mounting shell, a first accommodating slot is formed on the mounting shell; the first solar panel is arranged in the first accommodating slot; and the first solar panel is electrically connected to the battery and the circuit board through the electrical contact; and
wherein the mounting shell is connected with a cover body; the cover body is provided with a second accommodating slot; the solar panel module comprises a second solar panel; the second solar panel is arranged in the second accommodating slot; and the second solar panel is electrically connected to the circuit board and the battery.

24. The mosquito killer lamp according to claim 23, wherein the cover body is connected and rotated with the mounting shell through a rotating shaft mechanism; the rotating shaft mechanism is horizontally arranged between the cover body and the mounting shell, and the cover body is flipped up and down to cover the upper end face of the mounting shell through the rotating shaft mechanism; the cover body is provided with the second accommodating slot; and when the cover body is flipped to open, the first solar panel and the second solar panel work simultaneously.

25. The mosquito killer lamp according to claim 11, wherein the mounting shell comprises an upper shell and a base, the first light emitting unit is connected between the upper shell and base, the first light emitting unit comprises a light circuit board, a plurality of LEDs disposed on the light circuit board, a tube body receiving the light circuit board, and the high-voltage power grid are disposed around an outside of the first light emitting unit and connected between the upper shell and base.

26. The mosquito killer lamp according to claim 25, wherein the first light emitting unit further comprises a scattering layer disposed on the tube body, a first end cover disposed on an end of the tube body, a second end cover disposed on the other end of the tube body, at least one pin mounted on the first end cover, and an electrifying device disposed on the first end cover, the light circuit board is located in the tube body, the two ends of the light circuit board are connected to the second end cover and the electrifying device, the at least one pin is electrically connected to the electrifying device so as to electrically connect the light circuit board.

27. The mosquito killer lamp according to claim 17, further comprising a solar panel module connected to the mounting shell and electrically connected to the circuit board and the battery,
wherein the solar panel module comprises a first solar panel; and the first solar panel is arranged on the mounting shell, a first accommodating slot is formed on the mounting shell; the first solar panel is arranged in the first accommodating slot; and the first solar panel is electrically connected to the battery and the circuit board through the electrical contact; and
wherein the mounting shell is connected with a cover body; the cover body is provided with a second accommodating slot; the solar panel module comprises a second solar panel; the second solar panel is arranged in the second accommodating slot; and the second solar panel is electrically connected to the circuit board and the battery.

28. The mosquito killer lamp according to claim 27, wherein the first solar panel is disposed on an upper surface of the mounting shell, the cover body is rotatably connected with the mounting shell through a rotating shaft mechanism; the rotating shaft mechanism is horizontally arranged between the cover body and the mounting shell, and the cover body is flipped up and down to cover the upper surface of the mounting shell through the rotating shaft mechanism; the cover body is provided with the second accommodating slot; and when the cover body is flipped to open, the first solar panel and the second solar panel work simultaneously.

29. The mosquito killer lamp according to claim 17, wherein the first light emitting unit is connected between the upper shell and base, the first light emitting unit comprises a light circuit board, a plurality of LEDs disposed on the light circuit board, a tube body receiving the light circuit board, and the high-voltage power grid are disposed around an outside of the first light emitting unit and connected between the upper shell and base.

30. The mosquito killer lamp according to claim 29, wherein the first light emitting unit further comprises a scattering layer disposed on the tube body, a first end cover disposed on an end of the tube body, a second end cover disposed on the other end of the tube body, at least one pin mounted on the first end cover, and an electrifying device disposed on the first end cover, the light circuit board is located in the tube body, the two ends of the light circuit board are connected to the second end cover and the electrifying device, the at least one pin is electrically connected to the electrifying device so as to electrically connect the light circuit board.

31. The mosquito killer lamp according to claim 17, wherein the transparent cover body comprises an annular structure.

32. The mosquito killer lamp according to claim 31, wherein the plurality of LEDs of the second light emitting unit are arranged in at least one circle, and the annular structure comprises a cylindrical sidewall.

33. A mosquito killer lamp, comprising:
a first light emitting unit configured to emit light luring mosquitoes, the first light emitting unit comprising a light circuit board, a plurality of LEDs disposed on the light circuit board;
a mosquito killer unit comprising a high-voltage power grid, wherein the high-voltage power grid is configured to kill, under a high voltage, mosquitoes lured by the first light emitting unit;
a circuit board electrically connected to the first light emitting unit and the mosquito killer unit and configured to supply power to the first light emitting unit and the mosquito killer unit;
a mounting shell provided with a battery; the battery being electrically connected to the circuit board; the first light emitting unit and the mosquito killer unit being connected to the mounting shell; and
a second light emitting unit connected to the mounting shell, the second light emitting unit comprising a plurality of LEDs,
wherein a first stepless adjustment rotary knob is arranged on an outer surface of the mounting shell, the first stepless adjustment rotary knob is configured to adjust brightness of the LEDs of the second light emitting unit.

34. The mosquito killer lamp according to claim 33, wherein a second stepless adjustment rotary knob is arranged on an outer surface of the mounting shell; and the second stepless adjustment rotary knob is configured to adjust a wavelength of the LEDs of the first light emitting unit.

35. The mosquito killer lamp according to claim 33, further comprising a solar panel module connected to the mounting shell and electrically connected to the circuit board and the battery,
wherein the solar panel module comprises a first solar panel; and the first solar panel is arranged on the mounting shell, and the first solar panel is electrically connected to the battery and the circuit board through the electrical contact; and
wherein the mounting shell is rotatably connected with a cover body, the solar panel module comprises a second solar panel, the second solar panel is arranged on the cover body, and the second solar panel is electrically connected to the circuit board and the battery.
